(19) United States
(12) Patent Application Publication
(10) Pub. No.: US 2007/0236519 A1
(43) Pub. Date: Oct. 11, 2007

(54) Multi-Level Memory for Micro-Fluid Ejection Heads

(76) Inventors: John Glenn Edelen, Versailles, KY (US); Earl Lawrence Fugate, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/278,253

(22) Filed: Mar. 31, 2006

(51) Int. Cl. B41J 29/38

(52) U.S. Cl. 347/9

(57) ABSTRACT

Circuits for use with micro-fluid ejection devices, such as those having a memory array with floating gate transistors With one such memory array, a charge is stored on the gate of at least one transistor, and a current conducted by the transistor is affected by an amount of the charge stored on a gate of the transistor. A signal sensor resolves a current conducted by one of the transistors into one of more than two discrete states. One such signal sensor may be an analog-to-digital converter implemented by a neural network, and one such memory array may be part of a printhead.

### FIELD OF THE INVENTION

The present invention is directed to micro-fluid ejection heads and more particularly in one embodiment to a micro-fluid ejection head having multi-level memory.

### BACKGROUND OF THE INVENTION

A microfluid ejection head of a micro-fluid ejection device such as a print head on a printer (e.g., an ink-jet printer), typically includes a memory circuit on the head for storing various data. For example a memory circuit may store data such as a type of ink/toner cartridge being used, a type of printer, an amount of ink/toner used, diagnostic data and the like.

The memory circuit may be an array of memory cells. One such memory array is disclosed in co-assigned U.S. Patent Publication No. 2005/0099458 A1, entitled “Printhead Having Embedded Memory Device”, published on May 12, 2005 which discloses a floating gate memory array, such as one utilizing CMOS EPROM technology The floating gate memory array is a two-dimensional array of memory cells, wherein each cell may be programmed to store data. An alternative memory array is a fuse memory array.

A conventional floating gate memory array on a print head may conceptually operate as follows. Initially, each data cell is in a native (i.e., unprogrammed) state (e.g., a “0” state). The cell may be programmed to an alternative state (e.g., a “1” state) by applying a programming (sometimes also referred to as a “write mode”) voltage (e.g., 10 volts) to the cell, which basically charges a floating gate.

Thus, because the cell can represent one of two states, a bit of data may be “stored” in each memory cell Data can then be stored, one bit per cell, by selectively programming one or more of the cells in the array. Meanwhile, a bit of data may be read by applying a read mode voltage to a cell and measuring the generated current (where the read mode voltage should not be sufficient to write to/program the cell, e.g., 2.5 Volts). If the floating gate has been charged, the floating gate transistor should more readily conduct a current (as compared to the current it would conduct without a charge on its gate).

For example, if the generated current is greater than a threshold amount (e.g., about 50 microamps), the cell can be interpreted as being in a 1 state, If the generated current is less than the threshold, the cell can be interpreted as being in a 0 state As discussed in co-assigned U.S. patent application Ser. No. 11/322,417, entitled “Distributed Programmed Memory Cell Overwrite Protection, which was filed on Dec. 30, 2005, in some embodiments, the generated current might be compared to a reference current (e.g., using a current sense amplifier) to determine whether a particular cell is programmed or unprogrammed.

Accordingly, by reading a series of cells in the array, a binary digital signal can be produced. One current embodiment of such a memory circuit allows up to 4096 bits to be stored on the ejection head.

Understandably there is a continuing desire to store more data on such ejection heads. Unfortunately, expanding the memory capacity conventionally required larger memory arrays. Among other potential disadvantages this may require using more area on expensive components and/or materials, such as silicon. Therefore, there is an unresolved need in the art for, amongst other things, micro-fluid ejection heads with relatively small memory circuits arrays that have larger than conventional memory capacities.

### SUMMARY OF THE INVENTION

According to an exemplary embodiment of the invention, there is disclosed a circuit for use with a micro-fluid ejection device that has a memory array with floating gate transistors. A charge is stored on the gate of at least one transistor, and a current conducted by the transistor is affected by an amount of the charge stored on a gate of the transistor. A signal sensor resolves a current conducted by one of the transistors into one of more than two discrete states. The signal sensor may be an analog-to-digital converter implemented by a neural network, such as a fixed weight neural network.

In one embodiment the memory array is a multi-level memory disposed on a printhead.

When the signal sensor is implemented as one exemplary neural network, it has an input receiving a current conducted by one of the transistors. The current is an input signal. Primary transfer circuits are connected to the input, and each primary transfer circuit receives the input signal and amplifies or attenuates the input signal based on a weighting factor and produces primary weighted signals. Primary nodes receive the primary weighted signals, and each primary node produces a primary node signal based on a received primary weighted signal and a function associated with the primary node. Thus, the primary nodes produce primary node signals corresponding to the primary weighted signals modified by the functions associated with the primary nodes.

Exemplary secondary transfer circuits are connected between the primary nodes and secondary nodes, and the secondary transfer circuits produce a plurality of secondary weighted signals corresponding to the primary node signals amplified or attenuated based on the secondary weighting factors. The secondary nodes operate on the secondary weighted signals based on secondary functions and produce secondary node signals that are digital signals corresponding to the charges stored on the floating gate transistors. In this manner, the neural network converts the analog values of the charges on the transistor to digital information.

An exemplary circuit may include a programming source connected to charge at least some of the floating gate transistors to one of three or more different charge levels. In one embodiment, the source provides each transistor with one of three or more different charging pulses, each charging pulse having a different voltage. In another embodiment the programming source provides a number of pulses to the transistors, where the charge level on a transistor is determined by the number of pulses provided to such transistor.

Other embodiments, objects, features and advantages of the present invention will become apparent to those skilled in the a from the detailed descriptions the accompanying drawings and the appended claims.

### BRIEF DESCRIPTION OF THE DRAWINGS

Having thus described the invention in general terms reference will now be made to the accompanying drawings, which are not necessarily drawn to scale, and wherein:

FIG. 1 is a schematic diagram of a memory circuit which may be used in conjunction with an exemplary embodiment of the present invention.

FIG. 2 is a schematic diagram of an exemplary memory cell of the memory circuit of FIG. 1.

FIG. 3 is a chart illustrating the programming voltage for achieving various levels of read current in an exemplary memory circuit.

FIG. 4 is a graph illustrating read currents corresponding to four current ranges (Regions) representing distinct states in an exemplary memory circuit.

FIG. 5 is a schematic diagram illustrating a fixed weight neural network configured to function as an exemplary analog to digital converter (ADC).

FIG. 6 is a graph illustrating a function that may be used as an activation function in an exemplary neural network node;

FIG. 7 is a graph illustrating the overall function achieved by the exemplary neural network shown in FIG. 5; and

FIG. 8 is a block diagram showing a multi-level memory disposed on a printhead.

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein: rather, these embodiments are provided so that this disclosure will satisfy applicable legal requirements. Like numbers refer to like elements throughout.

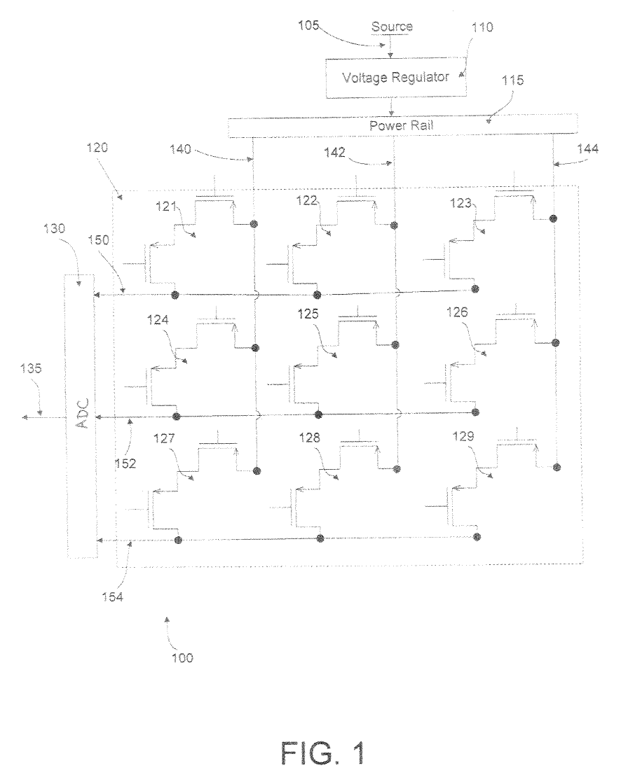

FIG. 1 is a schematic diagram of a memory circuit 100 that may be used in conjunction with an exemplary embodiment of the present invention. As shown in FIG. 1, memory circuit 100 can include a source, such as a voltage source or input 105, a voltage regulator 110, a power rail 115, an array 120 of memory cells 121, 122, 123, 124, 125, 126, 127, 128, 129, an analog to digital converter (ADC) 130, an output 135, feed lines 140, 142, 144 and exit lines 150, 152, 154.

The voltage regulator 110 regulates the voltage source or input 105 (e.g., 11 volts), which may be a battery, a connection to a printer power source (not shown) or the like, between a first voltage, corresponding to a read mode (e.g., 2.5 volts), and a second voltage(s), corresponding to a write mode(s) (e.g., 10 volts). An example of an acceptable voltage regulator 110 for use according to the present invention is the voltage regulating circuit described in U.S. patent application Ser. No. 10/961.465, filed on Oct. 8, 2004 (attorney docket no. 2004-0644), the relevant disclosure of which being incorporated herein by reference. A power rail 115 can be used to distribute the first and/or second voltages (depending on whether the circuit 100 is in the read mode or the write mode(s)) throughout the array 120 of memory cells 121, 122, 123, 124, 125, 126, 127, 128, 129 by way of the feed lines 140, 142, 144.

The array 120 may be a two-dimensional array of cells 121, 122, 123, 124, 125, 126, 127, 128, 129 comprised of X number of columns and Y number of rows to provide Z number of memory cells, where Z is equal to X times Y. The array 120 may be a floating gate memory array or other like memory array. For example, as illustrated in FIG. 1, the array 120 includes three columns and three rows for a total of nine memory cells 121, 122, 123, 124, 125, 126, 127, 128, 129. Array 120 may, however, include any number of rows and columns without departing from the scope of the present invention.

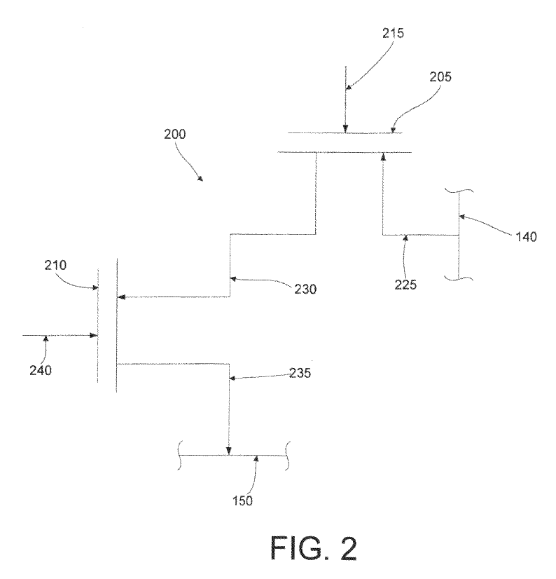

FIG. 2 is an enlarged view of an exemplary memory cell 200 which is representative of at least one of cells 121, 122, 123, 124, 125, 126, 127, 128, 129. Cell 200 includes a first transistor 205, a second transistor 210 that acts as a memory element, a first control input 215, input lead 225, connecting lead 230 and output lead 235. Input lead 225 is connected to feed line 140 and transistor 205. Connecting lead 230 is connected to transistor 205 and transistor 210. Output lead 235 is connected to transistor 210 and exit line 150. The first control input 215 (which may comprise for example logic decoded serial data) controls transistor 205 (e.g., switches transistor 205 on (active) such that current/voltage can pass or switches transistor 205 off (inactive) such that current/voltage cannot pass) by applying various voltages to the transistor 205. Transistor 210 acts as a memory element.

Applying a programming voltage to cell 200 causes the transistor 210 to behave as if the transistor control input 240 is active and the transistor 210 is switched on and passing voltage/current. Leaving transistor 210 in the unprogrammed/native state causes the transistor 210 to behave as if the transistor control input 240 is inactive and the transistor 210 is switched off and not passing voltage/current. When both transistors 205, 210 are active (i.e. switched on) current/voltage may enter and pass through the cell 200 (i.e. voltage may be applied to the cell by way of input lead 225 connected to the feed line 140 and output 235 connected to feed line 150).

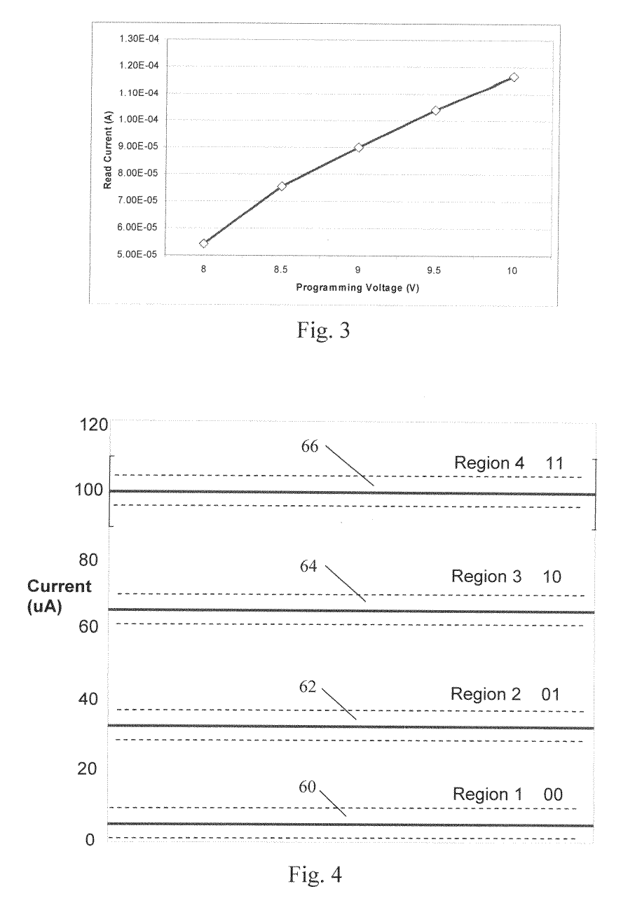

FIG. 3 illustrates an exemplary relationship between programming voltages and the current (labeled Read Current) that may be generated through an individual cell such as cell 200 (assuming a fixed programming time). As can be seen from FIG. 3 the Read Current increases substantially linearly with an increasing programming voltage. Conventionally cell 200 might have either been programmed or not programmed, depending on the state of the bit it was to store. If it was programmed, a programming voltage of sufficient amplitude and duration (e.g., 10 volts for 200 microseconds or longer) would have been applied by the power rail to charge the gate 240 of transistor 210 sufficient enough such that a current of greater than for example, 50 microamps (e.g., about 115 microamps) would be generated when a read mode voltage is applied to the cell. Accordingly, a conventional floating gate transistor on an ejection head would have only one of two different levels of charge placed on its floating gate to represent one of two different states.

By contrast, in one exemplary embodiment of the present invention, one of more than two different levels of charge are placed on gate 240 such that a single cell may be used to represent one of more than two different states. For example, in one exemplary embodiment, the different levels of charge are placed on gate 240 by using more than one programming voltages (also referred to herein as writing mode voltages). A discussion of one such embodiment is now discussed with respect to FIG. 3.

For example, a programming voltage of either 8, 8.5, 9, 9.5 or 10 volts may be applied for a fixed period of time of about 5 milliseconds by power rail 115, wherein a cell programmed with these programming voltages would respectively generate a read current of about 55, 75, 90, 105, and 115 microamps in response to an applied read mode voltage. In one such embodiment, for example, a voltage regulator might be used for voltage regulator 110 that has a control input(s) that regulates the voltage from source 105 between a read voltage and each of the five (5) different programming voltages. Such an exemplary control input(s) might be based on signals received from a device such as a printing apparatus, such as logic-decoded serial data. Accordingly, each of these five (5) different read currents might be used to respectively indicate one of five (5) different states. Therefore, a single cell which conventionally may have been used to store binary data (e.g., a 0 or 1 state) may now represent multi-level data (e.g., in the above example, 5 different states, more than doubling the data that can be stored on this single memory cell).

Another exemplary embodiment may be discussed with reference to FIG. 4. In FIG. 4, four unique regions (Regions 1, 2, 3 and 4) of read currents are depicted, wherein one of four different states (e.g., 00, 01, 10, or 11) is generated on an output signal depending on which of the regions the read current is in. More particularly, in such an embodiment, an associated memory circuit might charge a floating gate of a cell with one of four different programming voltages, such that a read current generated upon application of a read mode voltage would fall within one of four unique ranges respectively corresponding to each region.

For example referring to Region 1, a read current 60 of between 0 to 10 microamps might be interpreted as representing a 00 state. Meanwhile, referring to Region 2, a read current 62 between 30 to 40 microamps might be interpreted as representing a 01 state. Likewise, a read current 64 between 60 to 70 microamps might be interpreted as representing a 10 state, while a read current 66 between 95 to 105 microamps might be interpreted as representing a 11 state. Thus, a single cell may store charges representing four (4) possible states, essentially doubling the storage capacity of the memory cell as compared to a conventional memory cell on an ejection head.

While the system of programming a cell with one of different voltages over a fixed period of time may be useful in some applications, another exemplary programming method might use successive short pulses of a fixed voltage to program the cell. For example, referring to the proceeding example, if the memory circuit was attempting to program a cell to a 10 state (read current between 60 microamps and 70 microamps) the cell might be programmed with short 100 microsecond pulses of 9 volts each (e.g., by controlling the length of time of a corresponding state of a control input to voltage regulator 110). After each such pulse the cell might be read and once the desired read current and/or state is reached, a few additional pulses applied to push the program level safely above the threshold. In some cases, due to manufacturing variances, for example, different memories might require a different number of pulses to achieve the same charge. Thus, in an exemplary embodiment, each memory circuit should be calibrated and programmed to produce an appropriate number of pulses for charging a memory cell to the desired level. Accordingly, as can be appreciated, a variety of techniques may be used to appropriately program a cell of memory with more than two states.

Referring back to FIG. 1, an ADC 130, such as a current mode ADC, might be used to convert the read currents to an output signal (e.g., one capable of being read by a digital controller, such as a print controller on a printer) ADC 130 might be one of many different devices, circuits, and/or logic combinations which can implement such a conversion. One such ADC might be a flash (or parallel) converter.

An exemplary flash converter requires (2^{N}-1) comparators and 2^{N} resistors where N is the resolution of the converter. Accordingly, using such a flash converter to convert a read current signal into an output signal indicating one of four different states at a given instance, for example (such as what you might want to use with the example discussed with respect to FIG. 4), would require 15 comparators and 16 resistors. To increase the resolution to four different states would require 31 comparators and 32 resistors. Thus, for each additional state of resolution, the layout area required on an exemplary head effectively doubles. Therefore, this type of converter might not be desirable in some applications.

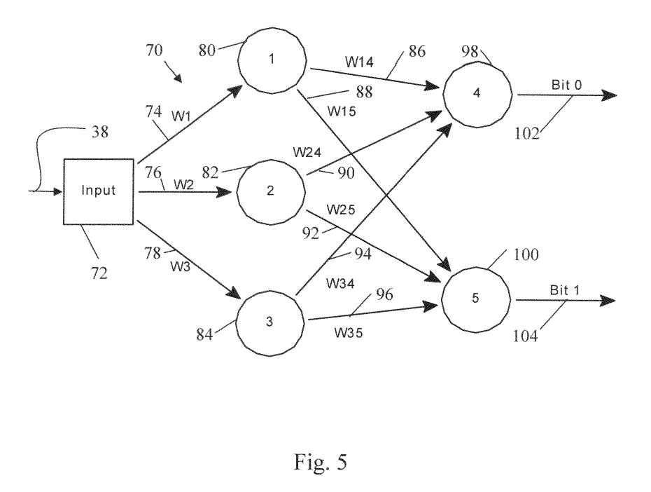

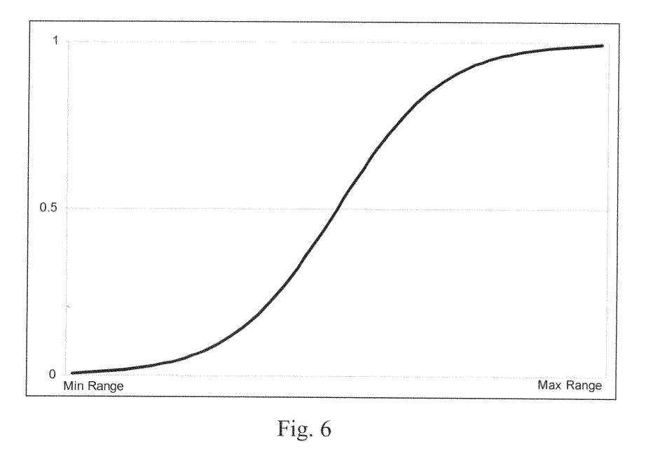

Another exemplary ADC 130 that might be used to convert a read current signal into an output signal, such as a digital read signal having one of four different states at a given instance, is illustrated in FIG. 5. In the illustrated embodiment, the ADC 130 is implemented as a fixed weight neural network. One such neural network 70 includes an input 72 that is in operative communication with (e.g., conductively connected to) output lines 38 (e.g., one or more of lines 150, 152, 154 in FIG. 1) of a memory array (e.g., memory array 120 of FIG. 1). Accordingly, a generated read current (referred to hereinafter as the input signal) is received at input 72 and transmitted by a transfer circuit 74, 76 and 78 to neural network modes 80, 82 and 84 respectively.

Each transfer circuit 74, 76 and 78 is associated with a respective weighting factor w1, w2 and w3, respectively. The transfer circuits amplify or attenuate the input signal based on the weighting factor. Thus, if the weighting factor is greater than 1 for example, the input signal is amplified, but if the weighting factor is less than 1, for example, the read current is attenuated.

The weighted signals on lines 74, 76 and 78 are modified by functions f1, f2 and f3 of nodes 80, 82 and 84, respectively. The signals modified by node 80, are transferred by transfer circuits 86 and 88, the signals modified by node 82 are transferred by transfer circuits 90 and 92, and the signals modified by node 84 is transferred by transfer circuits 94 and 96. Again, each of transfer circuits 86, 88, 90, 92, 94, and 96 is associated with a respective weighting factor W14, W15, W24, W25, W34 and W35, wherein the transfer circuits amplify or attenuate their respective signals.

Transfer circuits 86, 90 and 94 transfer signals from nodes 80, 82 and 84 to node 98. At node 98, these three signals are combined (e.g. using an adder) producing a signal on line 102, which represents one of two different states (e.g., a digital 1 or a digital 0). Similarly, transfer circuits 88, 92 and 96 transfer signals from nodes 80, 82 and 84 to node 100, where the three signals are combined (e.g., added) to produce a signal on line 104 that represents one of two different states (e.g., a digital 1 or a digital 0). Accordingly, the signal on line 102 may represent, for example a first bit (Bit 0) of a read signal while the signal on line 104 may represent, for example a second bit (Bit 1) of that read signal. Thus, it is appreciated that neural network 70 may receive a read current on line 38 and convert it to a digital read signal having one of four different states (Bit 0, Bit 1) at a given instance.

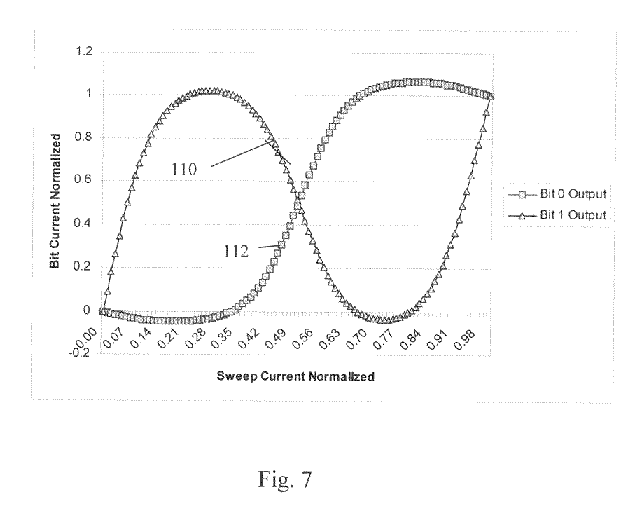

The operation of neural network 70 may be better understood by reference to FIGS. 6 and 7. For example, an exemplary activation function may be used by the nodes 80, 82 and 84 (FIG. 5) to operate on the respective weighted transfer signals. The inputs are shown on the horizontal axis and are defined within the range of minimum of a respective range to maximum of the respective range. The outputs of nodes 80, 82 and 84 are between 0 and 100% of the input signal.

The weighting steps are repeated in circuits 86-96 (FIG. 4) going to the next phase in the architecture at nodes 98 and 100. The weights are chosen such as to provide the desired outputs. In this exemplary embodiment, increasing storage capability does not necessarily dictate an increase in the size of the memory array.

Again, a fixed weight neural network may be chosen so as to yield a desired output. As an example, the above architecture was implemented in a 2 bit resolution embodiment (i.e., an embodiment capable of resolving a read current into one of four different states). The regions were defined to be a normalized current as follows. 0 microamps=0, 33 microamps=0.33, 66 microamps=0.66, and 100 microamps=1.0. It is important to note that the architecture is forgiving enough such that the inputs should not need to be as precise as defined. Variations due to noise should still provide accurate results, as shown below.

The overall operation of a neural network 70 is illustrated with respect to FIGS. 5 and 7, wherein curve 112 represents the output appearing on line 102 and curve 110 represents the output appearing on line 104. When the normalized read current is 0.00, lines 102 and 104 output a normalized current of 0. When the normalized read current is 0.33, the line 102 outputs a normalized current of 0 and line 104 outputs a normalized current of 1. Meanwhile, when the normalized read current is 0.66, line 102 outputs a normalized current of 1 and line 104 outputs a normalized current of 0. Finally, when the normalized read current to the system is 1.00, both lines 102 and 104 output a normalized current of 1.

Referring to the curves 110 and 112 it will be appreciated that the outputs should remain relatively constant even if the inputs to the network 70 vary somewhat dramatically from the ideal inputs. For example, by inspection of the curves it can be appreciated that even if the input to network 70 is 0.38 (38 microamps) instead of 0.33 (33 microamps), the output on line 102 should still be 0 and the output on line 104 should still be 1 (the curves change little for that particular region of inputs). Thus, the function has within it an inherent range of acceptable values for the inputs.

From the above discussion, it will be appreciated that a multi-level memory using floating gate memory cells as described above should increase the effective memory density on, for example, inkjet print head designs (and particularly on inkjet heater chip designs). Such an exemplary design allows for more memory on the same layout space, (or the same memory using less layout space) ultimately saving costs without sacrificing the functionality. While it will be understood that the invention is not limited to any particular one embodiment, mere exemplary embodiments have been disclosed.

Amongst other potential weighting factors, the list below illustrates some exemplary weighting factors and functions that may be used in the neural network 70 of FIG. 5.

| | | | |
|---|---|---|---|
| W1 = | 8.2532 | F1 = | 1/(1 + e^{-x}) |
| W2 = | −8.1928 | F2 = | 1/(1 + e^{-x}) |
| W3 = | 8.4031 | F3 = | 1/(1 + e^{-x}) |
| W14 = | 1.6572 | where X = | normalized input |
| W15 = | −0.2454 | F4 = | Σ inputs |
| W24 = | 0.6124 | F5 = | Σ inputs |
| W25 = | −0.6037 | | |
| W34 = | 0.9355 | | |
| W35 = | −0.028 | | |

When designing an exemplary neural network, the activation functions F1, F2 and F3 may be one of a variety of functions, and the functions F1, F2 and F3 may be the same as or different from each other. After the function F1, F2 and F3 are chosen, the weighting factors are adjusted to cause the network to have the desired overall function.

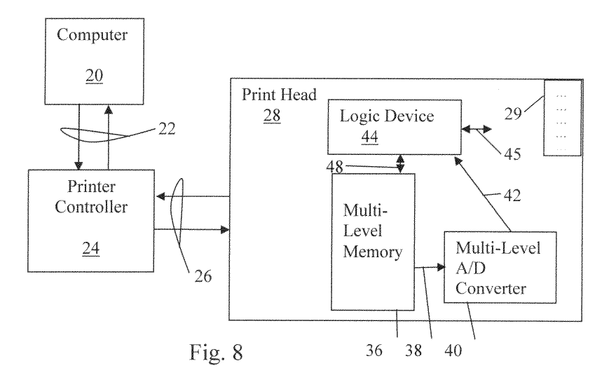

Referring now to FIG. 8 a schematic diagram of an exemplary embodiment is shown in which a multi-level memory 36 is provided on an inkjet printhead 28. In this embodiment, a computer 20 may be connected by a digital line(s) 22 to a printer controller 24, which may be on the main body of the printer, and the computer 20 may be separate from the printer. Alternatively, controller 24 might operate independently of a computer, such as when no computer is connected to the controller. The printer controller 24 is connected by a line(s) 26 to an inkjet printhead 28 that includes an inkjet nozzle array 29 from which ink may be expelled. The printhead 28 receives signals on the line(s) 26 and in response to those signals, expels ink from the nozzle array 29 to print, for example, a desired image or text on media. Some of the information may be decoded by logic device(s) 44 and used to write and/or read information from to multi-level memory 36. The information stored in the memory 36 may be read from the memory 36 through line(s) 38 which applies the memory signal(s) (e.g., a read current) to a multilevel analog to digital converter 40. The analog to digital converter 40 interprets the amplitude, for example, of the memory signal(s) and causes a corresponding one of multiple states in an output signal on line(s) 42. The signal on line(s) 42 may be operated on by printhead logic device 44 and/or communicated to other devices (e.g., through line 45 or directly from ADC 40).

In the embodiment illustrated in FIG. 8, the multi-level memory 36 may be programmed as described above (e.g. paragraphs 27-30) by the printer controller 24, or the memory 36 may be programmed by other devices, such as a programming device employed during manufacturing to pre-load information into the multi-level memory 36.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A circuit for use with a micro-fluid ejection device the circuit comprising:
a memory array comprising a plurality of floating gate transistors, wherein a charge can be stored on at least one of the floating gate transistors, and wherein a current conducted by the at least one of the transistors is affected by an amount of the charge stored on a gate of the transistor; and
a signal sensor capable of resolving a current conducted by one of the transistors into one of more than two discrete states.

2. The circuit of claim 1, wherein the signal sensor comprises an analog-to-digital convertor.

3. The circuit of claim 2, wherein the analog-to-digital convertor comprises a neural network.

4. The circuit of claim 3, wherein the neural network comprises a fixed-weight neural network.

5. The circuit of claim 1 wherein the signal sensor comprises a neural network having:
an input receiving a current conducted by one of the transistors as an input signal;
a plurality of parallel primary transfer circuits connected to the input, each primary transfer circuit having a weighting factor associated with the primary transfer circuit, each primary transfer circuit receiving the input signal and amplifying or attenuating the input signal based on the weighting factor of the primary transfer circuit to produce a plurality of primary weighted signals;
a plurality of primary nodes receiving the plurality of primary weighted signals, each primary node having a transfer function associated with the primary node, each primary node receiving one of the primary weighted signals and producing a primary node signal based on the primary weighted signal received by the primary node and the function associated with the primary node, so that the primary nodes produce a plurality of primary node signals corresponding to the primary weighted signals modified by the functions associated with the primary nodes;
a plurality of secondary nodes, a secondary function being associated with each secondary node;
a plurality of secondary transfer circuits connected between the primary nodes and the secondary nodes each transfer circuit having a secondary weighting factor associated with the secondary transfer circuit, each secondary transfer circuit receiving a primary node signal and producing a secondary weighted signal corresponding to the received primary node signal and the secondary weighting factor of the secondary transfer circuit, so that the secondary transfer circuits produce a plurality of secondary weighted signals corresponding to the primary node signals amplified or attenuated based on the secondary weighting factors of the secondary transfer circuits; and
the plurality of secondary nodes operating on the secondary weighted signals based on the secondary functions and producing secondary node signals.

6. The circuit of claim 1 further comprising a programming source connected to charge a plurality of the floating gate transistors to one of three or more different charge levels.

7. The circuit of claim 1 further comprising a programming source connected to charge a plurality of the floating gate transistors to one of three or more different charge levels by providing each transistor with one of three or more different charging pulses, each charging pulse having a different voltage.

8. The circuit of claim 1 further comprising a programming source connected to charge a plurality of the floating gate transistors to one of three or more different charge levels by providing a number of pulses to each of the plurality of transistors, where the charge level of each transistor is determined by the number of pulses provided to each transistor.

9. An inkjet printhead having multi-level memory.

10. The inkjet printhead of claim 9 further comprising:
a multi-level analog to digital converter for receiving a signal from the multi-level memory and for producing a digital signal corresponding to the signal;
whereby a set of information may be received by the printhead, stored as charges in the multi-level memory, retrieved from the memory as a set of currents, and converted to a digital signal corresponding to the set of information received by the printhead.

11. The printhead of claim 9 wherein the multi-level analog to digital converter comprises a neural network.

12. The printhead of claim 9 wherein the multi-level analog to digital converter comprises a fixed weight neural network.

13. The printhead of claim 9 wherein the multi-level analog to digital converter comprises a fixed weight neural network having:
an input receiving the signal from the multi-level memory;
a plurality of parallel primary transfer circuits connected to the input, each primary transfer circuit having a weighting factor associated with the primary transfer circuit, each primary transfer circuit receiving the signal from the multi-level memory and amplifying or attenuating the signal based on the weighting factor of the primary transfer circuit to produce a plurality of primary weighted signals;
a plurality of primary nodes receiving the plurality of primary weighted signals, each primary node having a transfer function associated with the primary node, each primary node receiving one of the primary weighted signals and producing a primary node signal based on the primary weighted signal received by the primary node and the function associated with the primary node, so that the primary nodes produce a plurality of primary node signals corresponding to the primary weighted signals modified by the functions associated with the primary nodes;
a plurality of secondary nodes, a secondary function being associated with each secondary node;
a plurality of secondary transfer circuits connected between the primary nodes and the secondary nodes, each transfer circuit having a secondary weighting factor associated with the secondary transfer circuit, each secondary transfer circuit receiving a primary node signal and producing a secondary weighted signal corresponding to the received primary node signal and the secondary weighting factor of the secondary transfer circuit, so that the secondary transfer circuits produce a plurality of secondary weighted signals corresponding to the primary node signals amplified or attenuated based on the secondary weighting factors of the secondary transfer circuits; and
the plurality of secondary nodes operating on the secondary weighted signals based on the secondary functions and producing secondary node signals.

14. The printhead of claim 9 further comprising:
a plurality of memory cells in the multi-level memory, each memory cell capable of storing more than two different charge levels, and
a programming source connected to charge a plurality of the floating memory cells to one of three or more different charge levels.

15. The printhead of claim 9 further comprising:
a plurality of memory cells in the multi-level memory, each memory cell capable of storing more than two different charge levels; and
a programming source connected to charge a plurality of the memory cells to one of three or more different charge levels by providing to each memory cell one of three or more different charging pulses, each charging pulse having a different voltage.

16. The printhead of claim 9 further comprising:
a plurality of memory cells in the multi-level memory, each memory cell capable of storing more than two different charge levels, and
a programming source connected to charge a plurality of the memory cell to one of three or more different charge levels by providing a number of pulses to each of the plurality of memory cells, where the charge level on each transistor is determined by the number of pulses provided to each transistor.
